(19) United States
(12) Patent Application Publication
(10) Pub. No.: US 2009/0127271 A1
(43) Pub. Date: May 21, 2009

(54) Method for Manufacturing Liner Component

(76) Inventor: Akifumi Muraoka, Oyama-shi (JP)

Correspondence Address: EDWARDS ANGELL PALMER & DODGE LLP, P.O. BOX 55874, BOSTON, MA, 02205, US

(21) Appl. No.: 12/225,431

(22) PCT Filed: Mar. 27, 2007
(86) PCT No.: PCT/JP2007/056305

§ 371 Date: Sep. 22, 2008

(30) Foreign Application Priority Data
Mar. 28, 2006 (JP) 2006-088107

(51) Int. Cl. F17C 1/02; C21D 8/10

(52) U.S. Cl. 220/586; 148/519

(57) ABSTRACT

A method for manufacturing a liner component includes the following five steps. First step of performing hot forging on an Al alloy material containing 0.4 to 1.2 mass % Si and 0.8 to 1.2 mass % Mg, the balance of the alloy material being Al and inevitable impurities, to thereby form a first intermediate product 11A including a dome-shaped portion 13 and a mouthpiece attachment portion 4A having a non-final shape. Second step of performing solution treatment on the first intermediate product 11A to thereby obtain a second intermediate product 11A. Third step of performing preliminary aging treatment on the second intermediate product 11A to thereby obtain a third intermediate product 11A. Fourth step of performing cold working on the mouthpiece attachment portion 4A of the third intermediate product 11A at a reduction ratio of 5 to 30% to thereby obtain a fourth intermediate product 11 in which the mouthpiece attachment portion 4A has a final shape. Fifth step of performing final aging treatment on the fourth intermediate product 11 to thereby obtain a final product. This method enables manufacture of a liner component which can reduce the weight and cost of a pressure vessel liner.

### TECHNICAL FIELD

The present invention relates to a method for manufacturing a liner component which constitutes a pressure vessel liner used in a pressure vessel for storing hydrogen gas or natural gas, which serve as fuels for generation of power, or a pressure vessel for storing oxygen gas used in the automobile industry, the housing industry, the aerospace industry, the healthcare industry, etc.

Herein, the term “aluminum” encompasses aluminum alloys in addition to pure aluminum, except for the case where the element symbol “Al” is used.

### BACKGROUND ART

In recent years, in order to abate air pollution, development of natural gas vehicles and fuel cell vehicles, whose exhaust gas is clean, has been proceeding. These vehicles carry a pressure vessel into which natural gas or hydrogen gas, which serves as a fuel, is charged under high pressure. In such an application, in order to extend cruising range, a further increase in the pressure of the charged gas is required.

A conventionally known a pressure vessel liner used in such a pressure vessel is formed of aluminum, and includes a tubular trunk and end plates which close opposite end openings of the trunk, wherein a tubular mouthpiece attachment portion is integrally formed on at least one of the end plates. The outer circumferential surface of the pressure vessel liner is covered by a fiber-reinforced resin layer in which a resin is impregnated into reinforcing fibers and cured. The thus-completed produce is used as a pressure vessel.

However, when the pressure of gas charged into the pressure vessel is increased, the strength of the mouthpiece attachment portion becomes insufficient, and the pressure vessel may break from the mouthpiece attachment portion.

In order to solve such a problem, there has been proposed a pressure vessel in which a reinforcement ring, which is formed of a material stronger than the material of the pressure vessel liner, is attached to an area around the mouthpiece attachment portion (see, for example, Patent Document 1).

However, in the case of the pressure vessel described in Patent Document 1, since a reinforcement ring is attached around the mouthpiece attachment portion, the pressure vessel has a problem of increased weight and cost.

Patent Document 1: Japanese Patent Application Laid-Open (kokai) No. 2004-197812

### DISCLOSURE OF THE INVENTION

### Problems to be Solved by the Invention

An object of the present invention is to solve the above-described problem and provide a method for manufacturing a liner component which can reduce the weight and cost of a pressure vessel liner, and can sufficiently increase the strength of a mouthpiece attachment portion of the pressure vessel liner.

### Means for Solving the Problems

To achieve the above object, the present invention comprises the following modes.

1) A method for manufacturing a liner component used as a second liner component which constitutes a pressure vessel liner together with a first liner component, the pressure vessel liner including a tubular trunk and dome-shaped end plates which close opposite end openings of the trunk, wherein the first liner component is a tubular member which is open at least one end thereof and constitutes the trunk, and the second liner component is joined to an open end portion of the first liner component and includes a dome-shaped portion that constitutes a corresponding end plate, and a mouthpiece attachment portion provided on the dome-shaped portion, the method comprising:

a first step of performing hot forging on an Al alloy material containing 0.4 to 1.2 mass % Si and 0.8 to 1.2 mass % Mg, the balance of the alloy material being Al and inevitable impurities, to thereby form a first intermediate product of the liner component, the first intermediate product including the dome-shaped portion that constitutes the corresponding end plate and the mouthpiece attachment portion provided on the dome-shaped portion, wherein at least the mouthpiece attachment portion has a non-final shape;

a second step of performing solution treatment on the first intermediate product to thereby obtain a second intermediate product;

a third step of performing preliminary aging treatment on the second intermediate product to thereby obtain a third intermediate product;

a fourth step of performing cold working on at least the mouthpiece attachment portion of the third intermediate product at a reduction ratio of 5 to 30% to thereby obtain a fourth intermediate product in which the dome-shaped portion and the mouthpiece attachment portion each have a final shape; and

a fifth step of performing final aging treatment on the fourth intermediate product to thereby obtain a final product.

As used herein, the terms “non-final shape” and “final shape” refer to corresponding shapes and sizes, except for qualities imparted by heat treatment.

2) A method for manufacturing a liner component according to par. 1), wherein the Al alloy material further contains at least one of 0.1 to 0.5 mass % Cu, 0.05 to 0.5 mass % Mn, 0.05 to 0.5 mass % Cr, and 0.5 mass % or less Fe.

3) A method for manufacturing a liner component according to par. 1), wherein, before the first step, homogenizing treatment is performed on the Al alloy material by maintaining the Al alloy material at a temperature within a range of 450 to 500° C.

4) A method for manufacturing a liner component according to par. 1), wherein the solution treatment of the second step is performed by maintaining the first intermediate product at a temperature within a range of 500 to 580° C. for 30 to 180 minutes.

5) A method for manufacturing a liner component according to par. 1), wherein the preliminary aging treatment of the third step is performed by maintaining the second intermediate product at a temperature within a range of 70 to 200° C.

6) A method for manufacturing a liner component according to par. 1), wherein the final aging treatment of the fifth step is performed by maintaining the fourth intermediate product at a temperature within a range of 150 to 200° C.

7) A method for manufacturing a pressure vessel liner which includes a tubular trunk and dome-shaped end plates closing opposite end openings of the trunk and which is composed of a first liner component which is a tubular member that is open at least one end thereof and constitutes the trunk, and a second liner component which is joined to an open end portion of the first liner component and includes a dome-shaped portion that constitutes a corresponding end plate, and a mouthpiece attachment portion provided on the dome-shaped portion, the method comprising:

manufacturing the second liner component by a method described in any of pars. 1) to 6); and

joining an open end portion of the dome-shaped portion of the second liner component to the open end opening of the first liner component.

8) A pressure vessel liner which includes a tubular trunk and dome-shaped end plates closing opposite end openings of the trunk and which is composed of a first liner component which is a tubular member that is open at least one end thereof and constitutes the trunk, and a second liner component which is joined to an open end portion of the first liner component and includes a dome-shaped portion that constitutes a corresponding end plate, and a mouthpiece attachment portion provided on the dome-shaped portion, wherein the second liner component is manufactured by a method described in any of claims 1 to 6, and the mouthpiece attachment portion has the highest strength among all the portions of the second liner component.

In the pressure vessel liner according to par. 8), the expression “the mouthpiece attachment portion has the highest strength among all the portions of the second liner component” encompasses a case where the strength of the mouthpiece attachment portion is equal to that of the dome-shaped portion.

Next, the methods of pars. 1) to 6) will be described in detail.

### (I) Al Alloy Material Used a Raw Material

Si: Si coexists with Mg and precipitates Mg₂Si grains within an alloy matrix to thereby improve the strength of the alloy. However, when the Si content is excessively low, a satisfactory strength-improving effect cannot be attained; and when the Si content is excessively high, hot forging workability lowers. Accordingly, the Si content must be set to fall within a range of 0.4 to 1.2 mass %, preferably, 0.7 to 0.8 mass %.

Mg: Mg coexists with Si and precipitates Mg₂Si grains within an alloy matrix to thereby improve the strength of the alloy. However, when the Mg content is excessively low, a satisfactory strength-improving effect cannot be attained; and when the Mg content is excessively high, workability and hardenability lower. Accordingly, the Mg content must be set to fall within a range of 0.8 to 1.2 mass %, preferably, 1.0 to 1.2 mass %.

In the Al alloy material in which Si and Mg coexist, preferably, the ratio of the Mg content and the Si content (=Mg/Si) is equal to or lower than 1.73.

Cu: Cu is present in the alloy matrix as a solid solution to thereby improve strength, and accelerates the precipitation of CuAl₂ and an Al—Cu—Mg alloy at the time of the final aging treatment. However, when the Cu content is excessively low, a satisfactory strength-improving effect cannot be attained; and when the Cu content is excessively high, corrosion resistant and workability lower. Accordingly, the Cu content is preferably set to fall within a range of 0.1 to 0.5 mass %, more preferably, 0.30 to 0.40 mass %.

Mn, Cr: Mn precipitates an Al—Mn (or Al—Mn—Si) compound in the alloy matrix, and Cr precipitates an Al—Cr compound in the alloy matrix, whereby each of Mn and Cr forms subgrains and maintains the formed subgrains. However, when their content is excessively low, a satisfactory subgrain-forming-effect and a satisfactory subgrain-maintaining-effect cannot be attained; and when their content is excessively high, coarse intermetallic compounds are produced, with a possible decrease in toughness, ductility, and hardenability. Accordingly, the Mn content is preferably set to fall within a range of 0.05 to 0.5 mass %, more preferably, 0.08 to 0.12 mass %. Further, the Cr content is preferably set to fall within a range of 0.05 to 0.5 mass %, more preferably, 0.15 to 0.25 mass %. Further, when the Al alloy material contains both of Mn and Cr, the subgrain-forming-effect and the subgrain-maintaining-effect are further enhanced.

Fe: Fe disperses within the alloy material in the form of an Al—Fe—Si compound, and prevents recrystallized grains from becoming coarse during the solution treatment. However, when the Fe content becomes excessive, coarse Al—Fe—Si compounds are produced, whereby elongation and corrosion resistant may drop. Accordingly, the Fe content is preferably set to 0.5 mass % or less, more preferably, to 0.20 to 0.30 mass %. Notably, in the method of par. 2), the expression “0.5 mass % or less Fe” does not encompass a case where the Fe content is 0 mass %.

### (II) Manufacturing Steps

Homogenizing treatment: Homogenizing treatment is performed in order to homogenize micro-segregation generated as a result of solidification at the time of casting, precipitate supersaturated solid solution elements generated as a result of the solidification, and cause a phase change of the metastable phase. In particular, in order to obtain a pinning effect through fine precipitation of a transition element compound added to the Al alloy material, preferably, the homogenizing treatment is performed by maintaining the Al alloy material at a temperature within a range of 450 to 500° C.

Hot forging: Hot forging converts the cast metal to have a fibrous structure, forms subgrains within the fibrous structure, and maintains the state after the solution treatment, to thereby increase strength. No particular limitations are imposed on the conditions of the hot forging; however, preferably, hot forging is performed by heating the Al alloy material to a temperature of about 400 to 500° C., with a mold temperature maintained at 100° C. or higher.

Solution treatment: Solution treatment sufficiently forms solid solutions of precipitates generated as a result of heating during hot forging, and retains the state of supersaturated solid solution down to room temperature. However, when the retention temperature is excessively low, solid solutions of the precipitates cannot be formed sufficiently; and when the retention temperature is excessively high, recrystallization becomes more likely to occur, possibly failing to obtain a desired strength. Accordingly, the retention temperature of the solution treatment is preferably set to fall within a range of 500 to 580° C., more preferably, 550 to 570° C. Notably, after the solution treatment, preferably, the Al aluminum alloy is immediately removed from a heating furnace, and is cooled rapidly by use of water of 80° C. or lower.

Preliminary aging treatment: Preliminary aging treatment has an effect of lowering the degree of supersaturation, to thereby suppress formation of coarse precipitates and nonuniform formation of precipitates on a dislocation line, which do not contribute to strength increase in the final aging treatment after cold working. However, when the retention temperature is excessively low, the above-mentioned effect cannot be attained to a sufficient level; and when the retention temperature is excessively high, precipitation through aging proceeds to thereby produce precipitations in amounts that would cancel out the effect of preliminary aging treatment. Accordingly, the retention temperature of the preliminary aging treatment is preferably set to fall within a range of 70 to 200° C., more preferably, 100 to 150° C.

Cold working: Cold working is performed to form the mouthpiece attachment portion into the final shape, while attaining an effect of increasing the number of precipitation nuclei at the time of the final aging treatment to thereby precipitate fine and dense precipitates, and an effect of hardening the mouthpiece attachment portion through imparting working strain thereto. However, when the reduction ratio of the cold working is excessively low, the above-mentioned effects cannot be attained sufficiently; and when the reduction ratio of cold working is excessively high, considerable hardening occurs as a result of the working, and elongation lowers. Accordingly, the reduction ratio of the cold working must be set to fall within a range of 5 to 30%, preferably, 10 to 20%.

Final aging treatment: Final aging treatment effectively produces precipitate—which contribute to increasing strength—from the supersaturated solid solution formed through the solution treatment. However, when the retention temperature is excessively low, a time required to obtain a desired performance becomes long; and when the retention temperature is excessively high, Mg₂Si grains become coarse, and the maximum strength attained after the final aging treatment lowers, possibly failing to obtain the desired strength. Accordingly, the retention temperature of the final aging treatment preferably falls within a range of to 200° C., more preferably, 170 to 190° C.

### EFFECT OF THE INVENTION

According to the method for manufacturing a liner component of par. 1), the strength of the mouthpiece attachment portion of the manufactured liner component can be increased sufficiently. Therefore, the mouthpiece attachment portion of a pressure vessel liner which uses this liner component has increased strength, and a reinforcement ring for the mouthpiece attachment portion, such as that of the pressure vessel liner described in Patent Document 1, becomes unnecessary. As a result, the weight and cost of the pressure vessel liner which uses this liner component can be lowered.

According to the methods of manufacturing a liner component of pars. 2) to 6), the strength of the mouthpiece attachment portion of the manufactured liner component can be increased effectively.

### BEST MODE FOR CARRYING OUT THE INVENTION

Embodiments of the present invention will next be described with reference to the drawings. Throughout the drawings, like sections or components are denoted by like reference numerals, and repeated description thereof is omitted.

FIGS. 1 and 2 show the overall structure of a pressure vessel liner of the present invention; and FIG. 3 shows a method for manufacturing one liner component (second liner component) used for the pressure vessel liner of FIGS. 1 and 2.

In FIGS. 1 and 2, a pressure vessel liner (1) includes a straight, cylindrical trunk (2) and partially spherical (dome-shaped) end plates (3) for closing opposite end openings of the trunk (2). One end plate (3) has an integrally formed mouthpiece attachment portion (4), which establishes communication between the inside and the outside of the pressure vessel liner (1). The mouthpiece attachment portion (4) has a through-hole (4a) extending from its outer end. An internal thread (5) is formed on the wall surface of the through-hole (4a).

The pressure vessel liner (1) is composed of a first liner component (10) made of aluminum, and second liner components (11) and (12) made of aluminum. The first liner component (10) is a straight, cylindrical member having opposite end openings. The second liner components (11) and (12) are generally cup-shaped members, and are connected to respective opposite end portions of the first liner component (10). The first liner component (10) forms a greater portion of the trunk (2). The second liner components (11) and (12) form opposite end portions of the trunk (2) and the end plates (3). One second liner component (11) includes the mouthpiece attachment portion (4) integrally formed thereon. The first liner component (10) is formed by, for example, hot extrusion. The second liner component (12), which does not have the mouthpiece attachment portion (4), is formed by, for example, hot forging.

Each of the second liner components (11) and (12) includes a partially spherical portion (13), which constitutes the corresponding end plate (3), and a short, cylindrical portion (14), which is continuous with an open end portion of the partially spherical portion (13) and constitutes a corresponding end portion of the trunk (2). The liner components (10), (11), and (12) are joined together, by means of friction stir welding, in a state in which the open end portions of the short, cylindrical portions (14) of the second liner components (11) and (12) are in contact with the opposite open end portions of the first liner component (10).

The first liner component (10) and the second liner component (12), which does not have the mouthpiece attachment portion (4), are formed from, for example, any one of a JIS A2000-family alloy, a JIS A5000-family alloy, a JIS A6000-family alloy, and a JIS A7000-family alloy. These liner components (10) and (12) may be formed from the same material or different materials.

The second liner component (11), which has the mouthpiece attachment portion (4), is formed from an Al alloy material containing 0.4 to 1.2 mass % Si and 0.8 to 1.2 mass % Mg, the balance of the alloy material being Al and inevitable impurities, or the Al alloy which additionally contains at least one of 0.1 to 0.5 mass % Cu, 0.05 to 0.5 mass % Mn, 0.05 to 0.5 mass % Cr, and 0.5 mass % or less of Fe.

Although not illustrated in the drawings, the entire circumference of the pressure vessel liner (1) is covered with a fiber-reinforced resin layer formed from, for example, a carbon-fiber-reinforced resin, and the pressure vessel liner (1) is used as a high-pressure pressure vessel. The fiber-reinforced resin layer includes a helically-wound reinforcement layer, which is formed by winding reinforcing fiber on the liner (1) along the longitudinal direction of the trunk (2) in such a manner as to partially cover the two end plates (3); a hoop-wound reinforcement layer, which is formed by winding reinforcing fiber on the trunk (2) along the circumferential direction; and a resin impregnated into these reinforcement layers and cured. The resin may be a thermosetting resin or a photo-setting resin.

The high-pressure pressure vessel is used as a fuel hydrogen storage pressure vessel for use in a fuel cell system, which includes the fuel storage pressure vessel, a fuel cell, and pressure piping for sending fuel hydrogen gas therethrough from the fuel hydrogen storage pressure vessel to the fuel cell. The fuel cell system is mounted in a fuel cell vehicle. The fuel cell system is also used in a cogeneration system.

The high-pressure pressure vessel is used as a natural gas storage pressure vessel for use in a natural gas supply system, which includes the natural gas storage pressure vessel, and pressure piping for delivering natural gas therethrough from the natural gas storage pressure vessel. The natural gas supply system, together with a generator and a generator drive apparatus, is used in a cogeneration system. The natural gas supply system is used in a natural gas vehicle equipped with a natural-gas-fueled engine.

Furthermore, the high-pressure pressure vessel is used as an oxygen storage pressure vessel for use in an oxygen gas supply system, which includes the oxygen storage pressure vessel, and pressure piping for delivering oxygen gas therethrough from the oxygen storage pressure vessel.

A gas, liquid, or fluid mixture of gas and liquid is charged into the pressure vessel which uses the above-described pressure vessel liner (1).

The above-described pressure vessel liner (1) is composed of a single first liner component (10) and two second liner components (11) and (12). However, the present invention is not limited thereto. The end plate (3), which does not have the mouthpiece attachment portion (4), may be formed integrally with the trunk (2). That is, a bottomed tubular member which is opened at one end and closed at the other end and which constitutes the trunk (2) and one end plate (3) may be used as the first liner component (10). In this case, the second liner component (11), which constitutes the end plate (3) having the mouthpiece attachment portion (4), is joined to the open end portion of the first liner component (10). The first liner component (10) assuming a bottomed tubular shape is formed by, for example, forging. Further, the first liner component may be composed of a plurality of liner components, which correspond to members obtained by dividing the first liner component along its longitudinal direction.

In the above-described pressure vessel liner (1), the trunk (2); i.e., the first liner component (10), has a circular transverse cross section. However, the present invention is not limited thereto, and the trunk (2); i.e., the first liner component (10), may have any other proper transverse cross section such as an elliptical transverse cross section. In this case, naturally, the end plates (3) have the form of a partial elliptical spheroid, and the second liner components (11) and (12) are replaced with those including a partial elliptical spheroid portion and a short elliptical tubular portion.

Next, a first embodiment of a method for manufacturing the second liner component (11), which has the mouthpiece attachment portion (4), will be described with reference to FIG. 3.

First, homogenization treatment is performed on an Al alloy material by maintaining it at a temperature within a range of 450 to 500° C. The Al alloy material contains 0.4 to 1.2 mass % Si and 0.8 to 1.2 mass % Mg, the balance of the alloy material being Al and inevitable impurities. The Al alloy material may further contain at least one of 0.1 to 0.5 mass % Cu, 0.05 to 0.5 mass % Mn, 0.05 to 0.5 mass % Cr, and 0.5 mass % or less of Fe.

Subsequently, the homogenized Al alloy material is heated to a temperature of about 400 to 500° C., and hot forging is performed thereon in a state in which the mold temperature is maintained at 100° C. or higher, to thereby form a first intermediate product (11A) of the second liner component (11). The first intermediate product (11A) has a shape as shown in FIG. 3(a); i.e., includes a dome-shaped portion (13), a short, cylindrical portion (14), and a mouthpiece attachment portion (4A) integrally formed on the dome-shaped portion (13) and including a through-hole (4a). The dome-shaped portion (13) and the short, cylindrical portion (14) of the first intermediate product (11A) have respective final shapes in terms of shape and size, except for qualities imparted by heat treatment. Meanwhile, the mouthpiece attachment portion (4A) has a non-final shape; i.e., a shape which is not final, in terms of shape and size, except for qualities imparted by heat treatment. Notably, the inner diameter of the through hole (4a) of the mouthpiece attachment portion (4A) is identical with that of a final product of the second liner component (11).

Next, solution treatment is performed on the first intermediate product (11A) by maintaining it at a temperature within a range of 500 to 580° C., preferably, 550 to 570° C., for 30 to 180 minutes. After completion of the solution treatment, the first intermediate product (11A) is immediately removed from a heating furnace, and is cooled rapidly by use of water of 80° C. or lower. Thus, a second intermediate product (11A) is obtained.

Next, preliminary aging treatment is performed on the second intermediate product (11A) by maintaining it at a temperature within a range of 70 to 200° C., more preferably, 100 to 150° C. Thus, a third intermediate product (11A) is obtained.

Next, as shown in FIG. 3(a), a male die (20) is fitted into the third intermediate product (11A), and a through-hole protector (21) is inserted into the through hole (4a) of the mouthpiece attachment portion (4A). Subsequently, as shown in FIG. 3(b), by use of a divided female die (22) composed of a plurality of die components (22a), cold working is performed, from the outer side, on only the mouthpiece attachment portion (4A) such that the reduction ratio becomes 5 to 30%, preferably, 10 to 20%. Thus, the mouthpiece attachment portion (4A) is formed into the final shape, whereby a fourth intermediate product (11) is obtained.

Subsequently, final aging treatment is performed on the fourth intermediate product (11) by maintaining it at a temperature within a range of 150 to 200° C., preferably, 170 to 190° C. Finally, a female thread (5) is formed on the wall surface of the through hole (4a) of the mouthpiece attachment portion (4). Thus, the second liner component (11) having the mouthpiece attachment portion (4) is manufactured.

FIG. 4 shows a second embodiment of the method for manufacturing the second liner component (11), which has the mouthpiece attachment portion (4).

First, homogenization treatment is performed on an Al alloy material by maintaining it at a temperature within a range of 450 to 500° C. The Al alloy material contains 0.4 to 1.2 mass % Si and 0.8 to 1.2 mass % Mg, the balance of the alloy material being Al and inevitable impurities. The Al alloy material may further contain at least one of 0.1 to 0.5 mass % Cu, 0.05 to 0.5 mass % Mn, 0.05 to 0.5 mass % Cr, and 0.5 mass % or less of Fe.

Subsequently, the homogenized Al alloy material is heated to a temperature of about 400 to 500° C., and hot forging is performed thereon in a state in which the mold temperature is maintained at 100° C. or higher, to thereby form a first intermediate product (11B) of the second liner component (11). The first intermediate product (11B) has a shape as shown in FIG. 4(a); i.e., includes a dome-shaped portion (13A), a short, cylindrical portion (14A), and a mouthpiece attachment portion (4A) integrally formed on the dome-shaped portion (13A) and including a through-hole (4a). The dome-shaped portion (13A), the short, cylindrical portion (14A), and the mouthpiece attachment portion (4A) of the first intermediate product (11B) have respective non-final shapes in terms of shape and size, except for qualities imparted by heat treatment. However, inside portions of the dome-shaped portion (13A) and the short, cylindrical portion (14A) have respective final shapes in terms of shape and size. Notably, the internal diameter of the through hole (4a) of the mouthpiece attachment portion (4A) is identical with that that of a final product of the second liner component (11).

Next, solution treatment is performed on the first intermediate product (11B) by maintaining it at a temperature within a range of 500 to 580° C., preferably, 550 to 570° C., for 30 to 180 minutes. After completion of the solution treatment, the first intermediate product (11B) is immediately removed from a heating furnace, and is cooled rapidly by use of water of 80° C. or lower. Thus, a second intermediate product (11B) is obtained.

Next, preliminary aging treatment is performed on the second intermediate product (11B) by maintaining it at a temperature within a range of 70 to 200° C., more preferably, 100 to 150° C. Thus, a third intermediate product (11B) is obtained.

Next, as shown in FIG. 4(a), the male die (20) is fitted into the third intermediate product (11B), and the through-hole protector (21) is inserted into the through hole (4a) of the mouthpiece attachment portion (4A). Subsequently, as shown in FIG. 4(b), by use of a divided female die (25) composed of a plurality of die components (25a), cold working is performed, from the outer side, on the dome-shaped portion (13A), the short, cylindrical portion (14A), and the mouthpiece attachment portion (4A) such that the reduction ratio becomes 5 to 30%, preferably, 10 to 20%. Thus, the third intermediate product (11B) is formed into the final shape, whereby a fourth intermediate product (11) is obtained.

Subsequently, final aging treatment is performed on the fourth intermediate product (11) by maintaining it at a temperature within a range of 150 to 200° C., preferably, 170 to 190° C. Finally, a female thread (5) is formed on the wall surface of the through hole (4a) of the mouthpiece attachment portion (4). Thus, the second liner component (11) having the mouthpiece attachment portion (4) is manufactured.

FIG. 5 shows a third embodiment of the method for manufacturing the second liner component (11), which has the mouthpiece attachment portion (4).

First, homogenization treatment is performed on an Al alloy material by maintaining it at a temperature within a range of 450 to 500° C. The Al alloy material contains 0.4 to mass % Si and 0.8 to 1.2 mass % Mg, the balance of the alloy material being Al and inevitable impurities. The Al alloy material may further contain at least one of 0.1 to 0.5 mass % Cu, 0.05 to 0.5 mass % Mn, 0.05 to 0.5 mass % Cr, and 0.5 mass % or less of Fe.

Subsequently, the homogenized Al alloy material is heated to a temperature of about 400 to 500° C., and hot forging is performed thereon in a state in which the mold temperature is maintained at 100° C. or higher, to thereby form a first intermediate product (11C) of the second liner component (11). The first intermediate product (11C) has a shape as shown in FIG. 5(a); i.e., includes a dome-shaped portion (13B), a short, cylindrical portion (14B), and a mouthpiece attachment portion (4A) integrally formed on the dome-shaped portion (13B) and including a through-hole (4a). The dome-shaped portion (13A), the short, cylindrical portion (14A), and the mouthpiece attachment portion (4A) of the first intermediate product (11C) have respective non-final shapes in terms of shape and size, except for qualities imparted by heat treatment. Notably, the internal diameter of the through hole (4a) of the mouthpiece attachment portion (4A) is identical with that of a final product of the second liner component (11).

Next, solution treatment is performed on the first intermediate product (11C) by maintaining it at a temperature within a range of 500 to 580° C., preferably, 550 to 570° C., for 30 to 180 minutes. After completion of the solution treatment, the first intermediate product (11C) is immediately removed from a heating furnace, and is cooled rapidly by use of water of 80° C. or lower. Thus, a second intermediate product (11C) is obtained.

Next, preliminary aging treatment is performed on the second intermediate product (11C) by maintaining it at a temperature within a range of 70 to 200° C., more preferably, 100 to 150° C. Thus, a third intermediate product (11C) is obtained.

Next, as shown in FIG. 5(a), the through-hole protector (21) is inserted into the through hole (4a) of the mouthpiece attachment portion (4A) of the third intermediate product (11C). Subsequently, as shown in FIG. 5(b), by use of the die (20) and the divided female die (25) composed of the plurality of die components (25a), cold working is performed, from the inner and outer sides, on the dome-shaped portion (13B), the short, cylindrical portion (14B), and the mouthpiece attachment portion (4A) such that the reduction ratio becomes 5 to 30%, preferably, 10 to 20%. Thus, the third intermediate product (11C) is formed into the final shape, whereby a fourth intermediate product (11) is obtained.

Subsequently, final aging treatment is performed on the fourth intermediate product (11) by maintaining it at a temperature within a range of 150 to 200° C., preferably, 170 to 190° C. Finally, a female thread (5) is formed on the wall surface of the through hole (4a) of the mouthpiece attachment portion (4). Thus, the second liner component (11) having the mouthpiece attachment portion (4) is manufactured.

Notably, in FIGS. 3 to 5, portions of each intermediate product, which are identical in shape and size with those of the second liner component (11), which is a complete product, are denoted by the same reference numerals as those of the second liner component (11), irrespective of heat treatment quality. This also applies to the entire intermediate product, and if the shape and size of an intermediate product is the same as the second liner component (11), which is a complete product, the intermediate product is denoted by reference numeral (11) irrespective of heat treatment quality. Moreover, in the description of the above-described first to third embodiments, the same reference numerals are used for the intermediate products irrespective of heat treatment quality, as long as their shapes and sizes are identical.

Now, Examples of the present invention will be described together with Comparative Examples. The methods of Examples and Comparative Examples correspond to the method of the first embodiment, which has been described with reference to FIG. 3.

### EXAMPLES 1 TO 30

A billet was formed from each of alloys having compositions shown in Table 1 by means of semi-continuous casting, and was maintained at 470° C. for 10 hours, to thereby perform homogenization treatment on the billet. Subsequently, an outer circumferential portion of the homogenized billet was cut so as to make an alloy material for forging. This alloy material for forging was heated to 450° C., and hot forging was performed on the alloy material by use of a die having a die temperature of 100° C. or higher, whereby a first intermediate product was formed. Subsequently, solution treatment was performed on the first intermediate product under respective conditions shown in Table 1. Immediately after completion of the solution treatment, the first intermediate product was cooled rapidly by use of water of 80° C. or lower, whereby a second intermediate product was obtained. Subsequently, the second intermediate product was left at room temperature for two days, and preliminary aging treatment was performed thereon under respective conditions shown in Table 1. After the preliminary aging treatment, the second intermediate product was cooled to room temperature by air, whereby a third intermediate product was obtained.

Subsequently, a male die was fitted into the third intermediate product, and a through-hole protector was inserted into the through hole of the mouthpiece attachment portion. After that, by use of a divided female die composed of a plurality of die components, cold working was performed on the mouthpiece attachment portion at a corresponding reduction ratio shown in Table 1, such that the mouthpiece attachment portion had a final shape, whereby a fourth intermediate product was obtained. After that, the fourth intermediate product was heated to and maintained at a respective temperature as shown in Table 1, to thereby perform final aging treatment thereon, whereby the second liner component was manufactured.

TABLE 1

| | | | | | | | | | Solution | | Cold | Preliminary | Final |
|---|---|---|---|---|---|---|---|---|---|---|---|---|---|
| | | | | | | | | | treatment | | working | aging | aging |
| | | Composition (mass %) | | | | | | | Temp. | Time | ratio | temp. | temp. |
| | | Al | Si | Mg | Fe | Cu | Mn | Cr | (° C.) | (min) | (%) | (° C.) | (° C.) |
| Examples | 1 | Bl. | 0.41 | 1.01 | 0.19 | — | — | — | 530 | 60 | 15 | 150 | 180 |
| | 2 | Bl. | 0.78 | 1.01 | 0.20 | — | — | — | 530 | 60 | 15 | 150 | 180 |
| | 3 | Bl. | 1.20 | 1.01 | 0.20 | — | — | — | 530 | 60 | 15 | 150 | 180 |
| | 4 | Bl. | 0.78 | 0.80 | 0.21 | — | — | — | 530 | 60 | 15 | 150 | 180 |
| | 5 | Bl. | 0.78 | 1.19 | 0.19 | — | — | — | 530 | 60 | 15 | 150 | 180 |
| | 6 | Bl. | 0.78 | 1.01 | 0.19 | — | — | — | 530 | 60 | 15 | 150 | 180 |
| | 7 | Bl. | 0.78 | 1.01 | 0.49 | — | — | — | 530 | 60 | 15 | 150 | 180 |
| | 8 | Bl. | 0.78 | 1.01 | 0.20 | 0.11 | — | — | 530 | 60 | 15 | 150 | 180 |
| | 9 | Bl. | 0.78 | 1.01 | 0.20 | 0.35 | — | — | 530 | 60 | 15 | 150 | 180 |
| | 10 | Bl. | 0.78 | 1.01 | 0.20 | 0.49 | — | — | 530 | 60 | 15 | 150 | 180 |
| | 11 | Bl. | 0.78 | 1.01 | 0.20 | — | 0.06 | — | 530 | 60 | 15 | 150 | 180 |
| | 12 | Bl. | 0.78 | 1.01 | 0.20 | — | 0.15 | — | 530 | 60 | 15 | 150 | 180 |
| | 13 | Bl. | 0.78 | 1.01 | 0.20 | — | 0.49 | — | 530 | 60 | 15 | 150 | 180 |
| | 14 | Bl. | 0.78 | 1.01 | 0.20 | — | — | 0.06 | 530 | 60 | 15 | 150 | 180 |
| | 15 | Bl. | 0.78 | 1.01 | 0.20 | — | — | 0.25 | 530 | 60 | 15 | 150 | 180 |
| | 16 | Bl. | 0.78 | 1.01 | 0.20 | — | — | 0.49 | 530 | 60 | 15 | 150 | 180 |
| | 17 | Bl. | 0.78 | 1.01 | 0.20 | 0.35 | 0.15 | — | 530 | 60 | 15 | 150 | 180 |
| | 18 | Bl. | 0.78 | 1.01 | 0.20 | 0.35 | — | 0.25 | 530 | 60 | 15 | 150 | 180 |
| | 19 | Bl. | 0.78 | 1.01 | 0.20 | — | 0.15 | 0.25 | 530 | 60 | 15 | 150 | 180 |
| | 20 | Bl. | 0.78 | 1.01 | 0.20 | 0.35 | 0.15 | 0.25 | 530 | 60 | 15 | 150 | 180 |
| | 21 | Bl. | 0.78 | 1.01 | 0.20 | 0.35 | 0.15 | 0.25 | 502 | 60 | 15 | 150 | 180 |
| | 22 | Bl. | 0.78 | 1.01 | 0.20 | 0.35 | 0.15 | 0.25 | 579 | 60 | 15 | 150 | 180 |
| | 23 | Bl. | 0.78 | 1.01 | 0.20 | 0.35 | 0.15 | 0.25 | 530 | 30 | 15 | 150 | 180 |
| | 24 | Bl. | 0.78 | 1.01 | 0.20 | 0.35 | 0.15 | 0.25 | 530 | 180 | 15 | 150 | 180 |
| | 25 | Bl. | 0.78 | 1.01 | 0.20 | 0.35 | 0.15 | 0.25 | 530 | 60 | 5 | 150 | 180 |
| | 26 | Bl. | 0.78 | 1.01 | 0.20 | 0.35 | 0.15 | 0.25 | 530 | 60 | 20 | 150 | 180 |
| | 27 | Bl. | 0.78 | 1.01 | 0.20 | 0.35 | 0.15 | 0.25 | 530 | 60 | 15 | 72 | 180 |
| | 28 | Bl. | 0.78 | 1.01 | 0.20 | 0.35 | 0.15 | 0.25 | 530 | 60 | 15 | 198 | 180 |
| | 29 | Bl. | 0.78 | 1.01 | 0.20 | 0.35 | 0.15 | 0.25 | 530 | 60 | 15 | 150 | 155 |
| | 30 | Bl. | 0.78 | 1.01 | 0.20 | 0.35 | 0.15 | 0.25 | 530 | 60 | 15 | 150 | 200 |

Note:
Bl.: balance

### COMPARATIVE EXAMPLES 1 TO 6

The second liner component was manufactured in the same manner as in the case of the above-described examples, except that the compositions of alloys, solution treatment conditions, preliminary aging treatment conditions, and final aging treatment conditions were set as shown in Table 2.

TABLE 2

| | | | | | | | | | Solution | | Cold | Preliminary | Final |
|---|---|---|---|---|---|---|---|---|---|---|---|---|---|
| | | | | | | | | | treatment | | working | aging | aging |
| | | Composition (mass %) | | | | | | | Temp. | Time | ratio | temp. | temp. |
| | | Al | Si | Mg | Fe | Cu | Mn | Cr | (° C.) | (min) | (%) | (° C.) | (° C.) |
| Comparative | 1 | Bl. | 0.39 | 1.01 | 0.19 | — | — | — | 530 | 60 | 15 | 150 | 180 |
| Examples | 2 | Bl. | 1.21 | 1.01 | 0.20 | — | — | — | 530 | 60 | 15 | 150 | 180 |
| | 3 | Bl. | 0.78 | 0.79 | 0.20 | — | — | — | 530 | 60 | 15 | 150 | 180 |
| | 4 | Bl. | 0.78 | 1.22 | 0.21 | — | — | — | 530 | 60 | 15 | 150 | 180 |
| | 5 | Bl. | 0.78 | 1.01 | 0.20 | 0.35 | 0.15 | 0.25 | 530 | 60 | 3 | 150 | 180 |
| | 6 | Bl. | 0.78 | 1.01 | 0.20 | 0.35 | 0.15 | 0.25 | 530 | 60 | 31 | 150 | 180 |

Note:
Bl.: balance

### Evaluation Test

A test piece was formed from the mouthpiece attachment portion of each of the second liner components manufactured in Examples 1 to 30 and Comparative Examples 1 to 6, and a tensile test was performed in accordance with a “metallic material tensile test method” of JIS Z2241 so as to measure tensile strength, offset yield strength, and elongation. Table 3 shows the measurement results.

TABLE 3

| | | Mechanical properties | | | |
|---|---|---|---|---|---|
| | | Tensile | Offset yield | | |
| | | strength | strength | Elongation | |
| | | (MPa) | (MPa) | (%) | Judgment |
| Examples | 1 | 375 | 355 | 17 | AA |
| | 2 | 390 | 370 | 15 | AA |
| | 3 | 410 | 385 | 13 | AA |
| | 4 | 370 | 345 | 17 | AA |
| | 5 | 390 | 360 | 13 | AA |
| | 6 | 385 | 360 | 19 | AA |
| | 7 | 395 | 370 | 13 | AA |
| | 8 | 395 | 370 | 17 | AA |
| | 9 | 400 | 380 | 16 | AA |
| | 10 | 405 | 385 | 13 | AA |
| | 11 | 370 | 345 | 19 | AA |
| | 12 | 390 | 360 | 18 | AA |
| | 13 | 380 | 345 | 16 | AA |
| | 14 | 370 | 350 | 20 | AA |
| | 15 | 390 | 365 | 19 | AA |
| | 16 | 380 | 355 | 17 | AA |
| | 17 | 410 | 380 | 18 | AA |
| | 18 | 420 | 400 | 17 | AA |
| | 19 | 390 | 365 | 20 | AA |
| | 20 | 430 | 410 | 18 | AA |
| | 21 | 395 | 375 | 18 | AA |
| | 22 | 420 | 400 | 17 | AA |
| | 23 | 400 | 385 | 17 | AA |
| | 24 | 410 | 390 | 18 | AA |
| | 25 | 390 | 370 | 15 | AA |
| | 26 | 430 | 410 | 16 | AA |
| | 27 | 405 | 385 | 20 | AA |
| | 28 | 380 | 360 | 19 | AA |
| | 29 | 420 | 400 | 18 | AA |
| | 30 | 405 | 385 | 20 | AA |
| Comparative | 1 | 345 | 305 | 19 | XX |
| Examples | 2 | 400 | 370 | 10 | BB |
| | 3 | 345 | 300 | 20 | XX |
| | 4 | 380 | 345 | 11 | XX |
| | 5 | 345 | 315 | 19 | XX |
| | 6 | 410 | 380 | 10 | BB |

AA in the column of “Judgment” of Table 3 represents that standard requirements; i.e., tensile strength: 350 MPa or greater, offset yield strength: 325 MPa or greater, and elongation: 12% or greater, are satisfied. BB represents that the standard requirements regarding tensile strength and offset yield strength are satisfied, but the standard requirement regarding elongation is not satisfied. XX represents that the standard requirements regarding tensile strength and offset yield strength are not satisfied.

The results shown in Table 3 demonstrate that the mouthpiece attachment portion of each second liner component manufactured in accordance with the method of the present invention satisfies all the standard requirements regarding tensile strength, offset yield strength, and elongation, and that the mouthpiece attachment portion has sufficient strength.

### INDUSTRIAL APPLICABILITY

A method for manufacturing a liner component of the present invention is suitable for manufacturing a liner component which constitutes a pressure vessel liner used in a pressure vessel for storing hydrogen gas or natural gas, which serve as fuels for generation of power, or a pressure vessel for storing oxygen gas, in various industries.

### BRIEF DESCRIPTION OF THE DRAWINGS

FIG. 1 Perspective view showing a pressure vessel liner manufactured by a method according to the present invention.

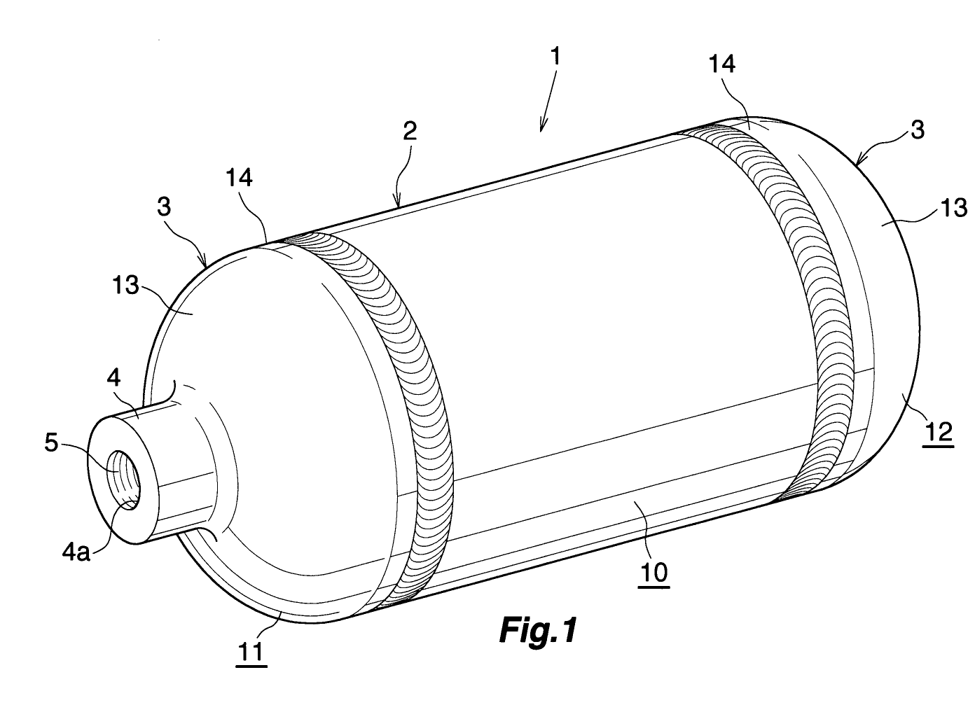

FIG. 2 Longitudinal cross sectional view of the pressure vessel liner of FIG. 1.

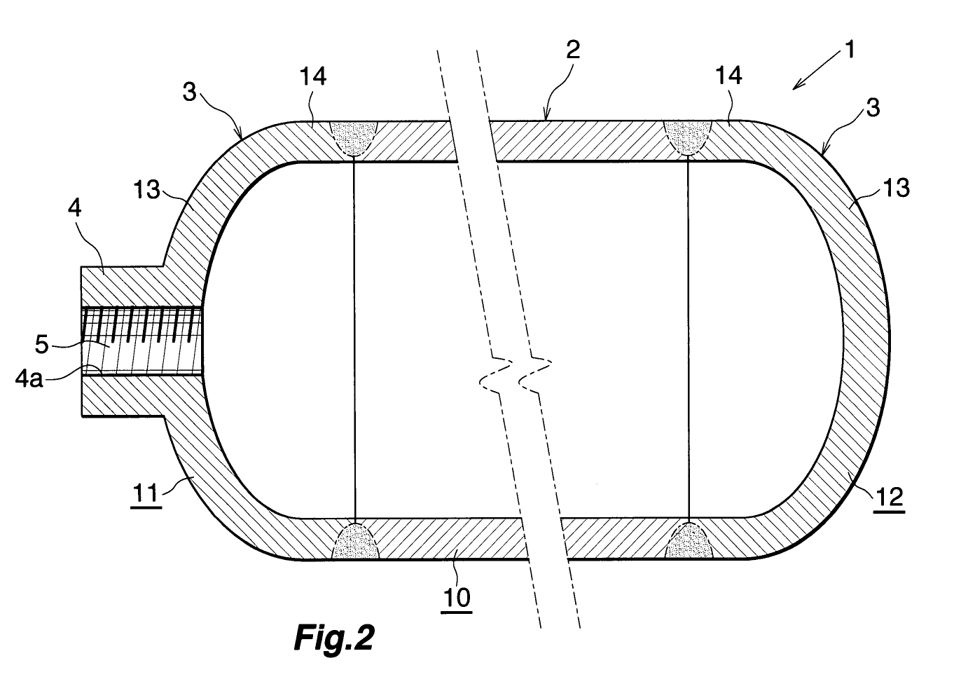

FIG. 3 Cross sectional views showing a portion of the steps of a method according to the first embodiment for manufacturing a second liner component of the pressure vessel liner of FIG. 1, which component has a mouthpiece attachment portion.

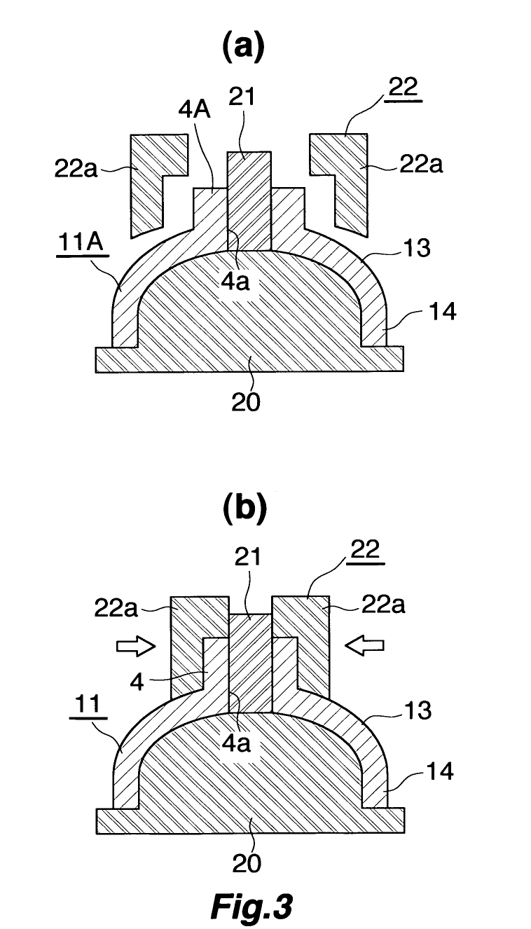

FIG. 4 Cross sectional views showing a portion of the steps of a method according to the second embodiment for manufacturing the second liner component of the pressure vessel liner of FIG. 1, which component has a mouthpiece attachment portion.

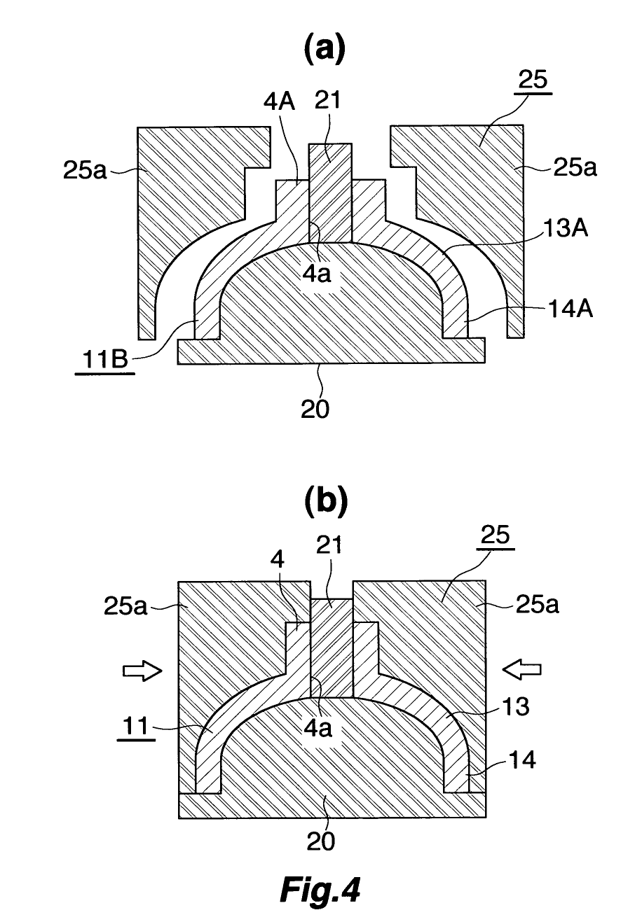

FIG. 5 Cross sectional views showing a portion of the steps of a method according to the third embodiment for manufacturing the second liner component of the pressure vessel liner of FIG. 1, which component has a mouthpiece attachment portion.

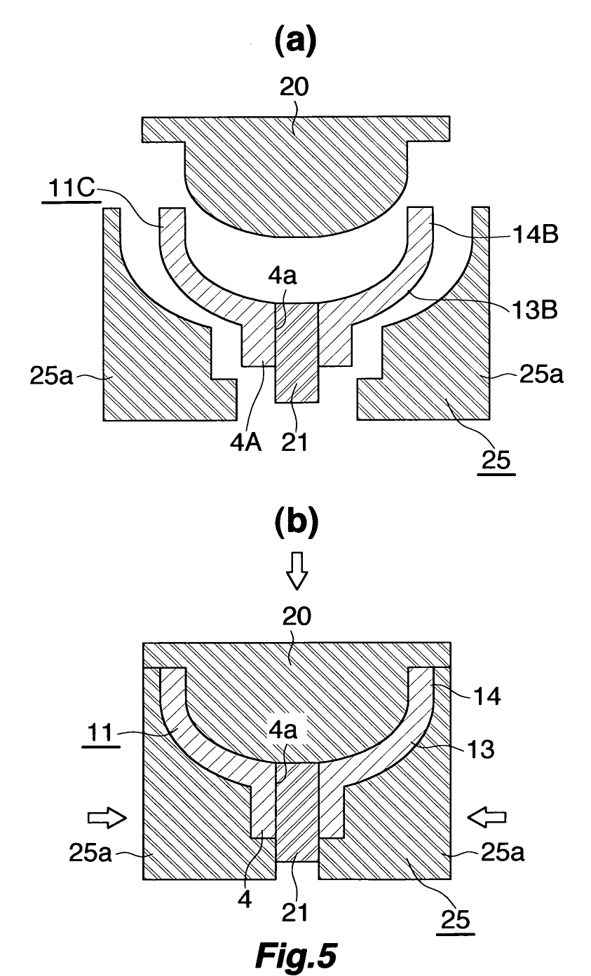

1: A method for manufacturing a liner component used as a second liner component which constitutes a pressure vessel liner together with a first liner component, the pressure vessel liner including a tubular trunk and dome-shaped end plates which close opposite end openings of the trunk, wherein the first liner component is a tubular member which is open at least one end thereof and constitutes the trunk, and the second liner component is joined to an open end portion of the first liner component and includes a dome-shaped portion that constitutes a corresponding end plate, and a mouthpiece attachment portion provided on the dome-shaped portion, the method comprising:
a first step of performing hot forging on an Al alloy material containing 0.4 to 1.2 mass % Si and 0.8 to 1.2 mass % Mg, the balance of the alloy material being Al and inevitable impurities, to thereby form a first intermediate product of the liner component, the first intermediate product including the dome-shaped portion that constitutes the corresponding end plate and the mouthpiece attachment portion provided on the dome-shaped portion, wherein at least the mouthpiece attachment portion has a non-final shape;
a second step of performing solution treatment on the first intermediate product to thereby obtain a second intermediate product;
a third step of performing preliminary aging treatment on the second intermediate product to thereby obtain a third intermediate product;
a fourth step of performing cold working on at least the mouthpiece attachment portion of the third intermediate product at a reduction ratio of 5 to 30% to thereby obtain a fourth intermediate product in which the dome-shaped portion and the mouthpiece attachment portion each have a final shape; and
a fifth step of performing final aging treatment on the fourth intermediate product to thereby obtain a final product.

2: A method for manufacturing a liner component according to claim 1, wherein the Al alloy material further contains at least one of 0.1 to 0.5 mass % Cu, 0.05 to 0.5 mass % Mn, 0.05 to 0.5 mass % Cr, and 0.5 mass % or less Fe.

3: A method for manufacturing a liner component according to claim 1, wherein, before the first step, homogenizing treatment is performed on the Al alloy material by maintaining the Al alloy material at a temperature within a range of 450 to 500° C.

4: A method for manufacturing a liner component according to claim 1, wherein the solution treatment of the second step is performed by maintaining the first intermediate product at a temperature within a range of 500 to 580° C. for 30 to 180 minutes.

5: A method for manufacturing a liner component according to claim 1, wherein the preliminary aging treatment of the third step is performed by maintaining the second intermediate product at a temperature within a range of 70 to 200° C.

6: A method for manufacturing a liner component according to claim 1, wherein the final aging treatment of the fifth step is performed by maintaining the fourth intermediate product at a temperature within a range of 150 to 200° C.

7: A method for manufacturing a pressure vessel liner which includes a tubular trunk and dome-shaped end plates closing opposite end openings of the trunk and which is composed of a first liner component which is a tubular member that is open at least one end thereof and constitutes the trunk, and a second liner component which is joined to an open end portion of the first liner component and includes a dome-shaped portion that constitutes a corresponding end plate, and a mouthpiece attachment portion provided on the dome-shaped portion, the method comprising:
manufacturing the second liner component by a method according to claim 1; and
joining an open end portion of the dome-shaped portion of the second liner component to the open end opening of the first liner component.

8: A pressure vessel liner which includes a tubular trunk and dome-shaped end plates closing opposite end openings of the trunk and which is composed of a first liner component which is a tubular member that is open at least one end thereof and constitutes the trunk, and a second liner component which is joined to an open end portion of the first liner component and includes a dome-shaped portion that constitutes a corresponding end plate, and a mouthpiece attachment portion provided on the dome-shaped portion,
wherein the second liner component is manufactured by a method according to claim 1, and the mouthpiece attachment portion has the highest strength among all the portions of the second liner component.

9: A method for manufacturing a pressure vessel liner which includes a tubular trunk and dome-shaped end plates closing opposite end openings of the trunk and which is composed of a first liner component which is a tubular member that is open at least one end thereof and constitutes the trunk, and a second liner component which is joined to an open end portion of the first liner component and includes a dome-shaped portion that constitutes a corresponding end plate, and a mouthpiece attachment portion provided on the dome-shaped portion, the method comprising:
manufacturing the second liner component by a method according to claim 2; and
joining an open end portion of the dome-shaped portion of the second liner component to the open end opening of the first liner component.

10: A method for manufacturing a pressure vessel liner which includes a tubular trunk and dome-shaped end plates closing opposite end openings of the trunk and which is composed of a first liner component which is a tubular member that is open at least one end thereof and constitutes the trunk, and a second liner component which is joined to an open end portion of the first liner component and includes a dome-shaped portion that constitutes a corresponding end plate, and a mouthpiece attachment portion provided on the dome-shaped portion, the method comprising:
manufacturing the second liner component by a method according to claim 3; and
joining an open end portion of the dome-shaped portion of the second liner component to the open end opening of the first liner component.

11: A method for manufacturing a pressure vessel liner which includes a tubular trunk and dome-shaped end plates closing opposite end openings of the trunk and which is composed of a first liner component which is a tubular member that is open at least one end thereof and constitutes the trunk, and a second liner component which is joined to an open end portion of the first liner component and includes a dome-shaped portion that constitutes a corresponding end plate, and a mouthpiece attachment portion provided on the dome-shaped portion, the method comprising:
manufacturing the second liner component by a method according to claim 4; and
joining an open end portion of the dome-shaped portion of the second liner component to the open end opening of the first liner component.

12: A method for manufacturing a pressure vessel liner which includes a tubular trunk and dome-shaped end plates closing opposite end openings of the trunk and which is composed of a first liner component which is a tubular member that is open at least one end thereof and constitutes the trunk, and a second liner component which is joined to an open end portion of the first liner component and includes a dome-shaped portion that constitutes a corresponding end plate, and a mouthpiece attachment portion provided on the dome-shaped portion, the method comprising:
manufacturing the second liner component by a method according to claim 5; and
joining an open end portion of the dome-shaped portion of the second liner component to the open end opening of the first liner component.

13: A method for manufacturing a pressure vessel liner which includes a tubular trunk and dome-shaped end plates closing opposite end openings of the trunk and which is composed of a first liner component which is a tubular member that is open at least one end thereof and constitutes the trunk, and a second liner component which is joined to an open end portion of the first liner component and includes a dome-shaped portion that constitutes a corresponding end plate, and a mouthpiece attachment portion provided on the dome-shaped portion, the method comprising:
manufacturing the second liner component by a method according to claim 6; and
joining an open end portion of the dome-shaped portion of the second liner component to the open end opening of the first liner component.

14: A pressure vessel liner which includes a tubular trunk and dome-shaped end plates closing opposite end openings of the trunk and which is composed of a first liner component which is a tubular member that is open at least one end thereof and constitutes the trunk, and a second liner component which is joined to an open end portion of the first liner component and includes a dome-shaped portion that constitutes a corresponding end plate, and a mouthpiece attachment portion provided on the dome-shaped portion,
wherein the second liner component is manufactured by a method according to claim 2, and the mouthpiece attachment portion has the highest strength among all the portions of the second liner component.

15: A pressure vessel liner which includes a tubular trunk and dome-shaped end plates closing opposite end openings of the trunk and which is composed of a first liner component which is a tubular member that is open at least one end thereof and constitutes the trunk, and a second liner component which is joined to an open end portion of the first liner component and includes a dome-shaped portion that constitutes a corresponding end plate, and a mouthpiece attachment portion provided on the dome-shaped portion,
wherein the second liner component is manufactured by a method according to claim 3, and the mouthpiece attachment portion has the highest strength among all the portions of the second liner component.

16: A pressure vessel liner which includes a tubular trunk and dome-shaped end plates closing opposite end openings of the trunk and which is composed of a first liner component which is a tubular member that is open at least one end thereof and constitutes the trunk, and a second liner component which is joined to an open end portion of the first liner component and includes a dome-shaped portion that constitutes a corresponding end plate, and a mouthpiece attachment portion provided on the dome-shaped portion,
wherein the second liner component is manufactured by a method according to claim 4, and the mouthpiece attachment portion has the highest strength among all the portions of the second liner component.

17: A pressure vessel liner which includes a tubular trunk and dome-shaped end plates closing opposite end openings of the trunk and which is composed of a first liner component which is a tubular member that is open at least one end thereof and constitutes the trunk, and a second liner component which is joined to an open end portion of the first liner component and includes a dome-shaped portion that constitutes a corresponding end plate, and a mouthpiece attachment portion provided on the dome-shaped portion,
wherein the second liner component is manufactured by a method according to claim 5, and the mouthpiece attachment portion has the highest strength among all the portions of the second liner component.

18: A pressure vessel liner which includes a tubular trunk and dome-shaped end plates closing opposite end openings of the trunk and which is composed of a first liner component which is a tubular member that is open at least one end thereof and constitutes the trunk, and a second liner component which is joined to an open end portion of the first liner component and includes a dome-shaped portion that constitutes a corresponding end plate, and a mouthpiece attachment portion provided on the dome-shaped portion,
wherein the second liner component is manufactured by a method according to claim 6, and the mouthpiece attachment portion has the highest strength among all the portions of the second liner component.
